(19) United States
(12) Patent Application Publication
(10) Pub. No.: US 2013/0259555 A1
(43) Pub. Date: Oct. 3, 2013

(54) IMAGE FORMING MEMBER AND IMAGE FORMING APPARATUS

(71) Applicant: OKI DATA CORPORATION, Tokyo (JP)

(72) Inventor: Masahiro HARUYAMA, Tokyo (JP)

(73) Assignee: Oki Data Corporation, Tokyo (JP)

(21) Appl. No.: 13/852,307

(22) Filed: Mar. 28, 2013

(30) Foreign Application Priority Data
Mar. 30, 2012 (JP) 2012-081741

(51) Int. Cl. G03G 15/00

(52) U.S. Cl. CPC G03G 15/6576
USPC 399/406

(57) ABSTRACT

An image forming member includes a rotation body that is configured to rotate in contact with a medium and to form an image on the medium, and a separation member that is positioned in contact with or in a vicinity of the surface of the rotation body and that separates the medium attached to the rotation body. The separation member includes a plurality of partial contact parts formed along a rotational axis direction of the rotation body, and a plurality of ridge parts respectively formed from the partial contact parts toward the downstream of a carrying direction of the medium.

### CROSS REFERENCE TO RELATED APPLICATION

The present application is related to, claims priority from and incorporates by reference Japanese Patent Application No. 2012-081741, filed on Mar. 30, 2012.

### TECHNICAL FIELD

The present invention relates to an image forming member and an image forming apparatus.

### BACKGROUND

For example, in an image forming apparatus such as copier, printer, facsimile machine, multifunction machine and the like utilizing a conventional electrographic method, a medium on which a developer image is formed is carried to an image forming unit as a development device and the transfer roller corresponding to the development device, and to a fusion device in order to fix a developer image after the developer image is transferred onto the medium surface, (see JP Laid-Open Patent Application No. 2008-015163 for example).

Among such image forming apparatuses, there are ones equipped with a separation member for separating a medium attached to the surface of a photosensitive drum in the downstream side of a nip part formed by the photosensitive drum installed inside an image forming unit and a transfer roller installed facing the photosensitive drum, in the medium carrying direction.

However, in an image forming apparatus having the above-described configuration, there was a problem that, if the front end of a medium curls toward the surface side of a photosensitive drum, for example, the medium contacts with the surface of the separation member, smearing a developer image transferred onto the medium surface. This kind of curling of a medium tends to occur at the time of double-side printing using a medium with small paper thickness (thin paper) or moisture-absorbed medium, in which case the smear of the developer image tends to become significant.

The present invention is made considering such a situation, and one of aspects of the present invention is to provide a development device and an image forming apparatus which can carry a medium well without smearing a developer image transferred onto the surface of the medium even when the front end of the medium curls toward the surface side of a photosensitive drum.

### SUMMARY

Considering the above objet, an image forming member disclosed in the application includes a rotation body that is configured to rotate in contact with a medium and to form an image on the medium, and a separation member that is positioned in contact with or in a vicinity of the surface of the rotation body and that separates the medium attached to the rotation body. The separation member includes a plurality of partial contact parts formed along a rotational axis direction of the rotation body, and a plurality of ridge parts respectively formed from the partial contact parts toward the downstream of a carrying direction of the medium.

In other view, an image forming apparatus disclosed in the application includes the above image forming member, a transfer device that is configured to transfer a developer image carried on the rotation body onto the medium, and a fusion device that is configured to fix the developer image transferred onto the medium. The rotation body is an image carrier.

According to the present invention, a development device and an image forming apparatus can be provided which can carry a medium well without smearing a developer image transferred onto the surface of the medium even when the front end of a medium curls toward the surface side of a photosensitive drum.

### BRIEF DESCRIPTION OF THE DRAWINGS

FIG. 1 is a schematic diagram for explaining a configuration of a printer as an image forming apparatus.

FIG. 2A is a block diagram for explaining a control mechanism of a first embodiment.

FIG. 2B is a block diagram for explaining the control mechanism of the first embodiment.

FIG. 3-1 is a bottom perspective view of a development part of the first embodiment.

FIG. 3-2 is a perspective view of a contact part of the first embodiment.

FIGS. 3-3A and 3-3B are a bottom view and an F-F cross-sectional view of the contact part of the first embodiment.

FIG. 4-1 is a drawing for explaining the actions of a development part of the first embodiment while carrying a medium.

FIG. 4-2 is a drawing for explaining the actions of a development part of the first embodiment while carrying a medium.

FIG. 4-3 is a drawing for explaining the actions of a development part of the first embodiment while carrying a medium.

FIG. 4-4 is a drawing for explaining the actions of a development part of the first embodiment while carrying a medium.

FIG. 5-1 is a drawing for explaining a modification example of the first embodiment.

FIG. 5-2 is a drawing for explaining a modification example of the first embodiment.

FIGS. 5-3A and 5-3B are drawings for explaining a modification example of the first embodiment.

FIG. 6 is a drawing for explaining a modification example of the first embodiment.

FIG. 7-1 is a bottom perpendicular view of a development part of a second embodiment.

FIG. 7-2 is a perspective view of a contact part of the second embodiment.

FIGS. 7-3A and 7-3B are a bottom view and a G-G cross-sectional view of a contact part of the second embodiment.

FIG. 8-1 is a drawing for explaining the actions of a development part of the second embodiment while carrying a medium.

FIG. 8-2 is a drawing for explaining the actions of a development part of the second embodiment while carrying a medium.

FIG. 8-3 is a drawing for explaining the actions of a development part of the second embodiment while carrying a medium.

FIG. 8-4 is a drawing for explaining the actions of a development part of the second embodiment while carrying a medium.

### DETAILED DESCRIPTION OF THE EMBODIMENTS

Below, embodiments of the present invention are explained referring to the drawings. Here, the present invention is not limited to the following descriptions but can be appropriately modified within the scope not deviating from the substance of the present invention.

### First Embodiment

First, a printer as an image forming apparatus is explained, and next, an image forming unit as a development device is explained.

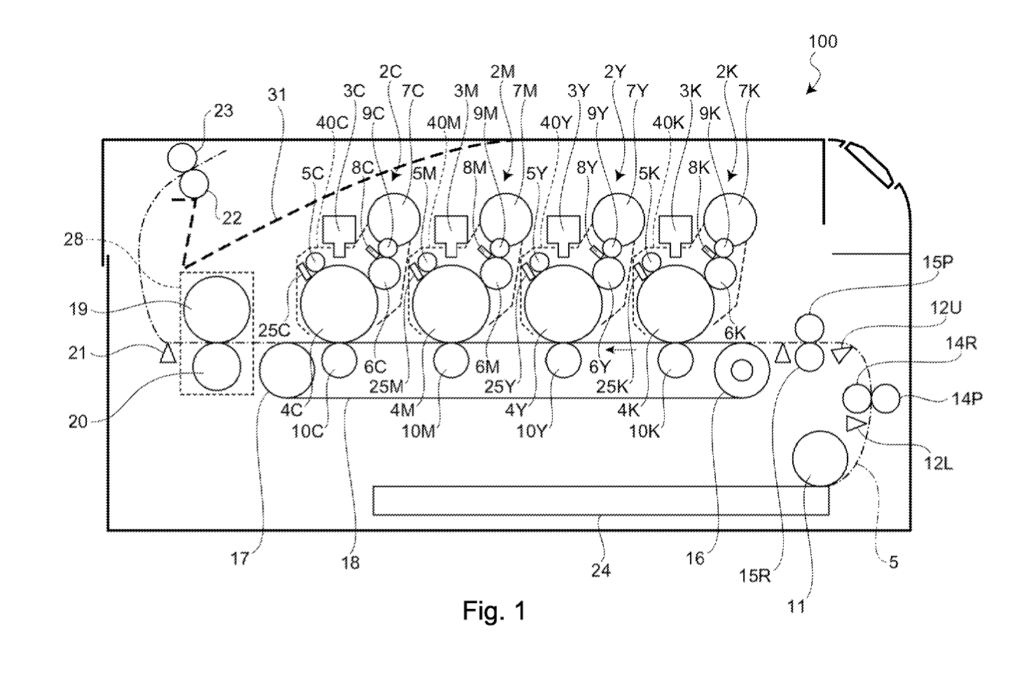

FIG. 1 is a schematic diagram for explaining a printer 100 as an image forming apparatus. The printer 100 is an image forming apparatus which forms an image on a sheet P as a medium by an electrographic method. The printer 100 which realizes such a function includes a first entrance sensor 12L, first carrying rollers 14R and 14P, a second entrance sensor 12U, second carrying rollers 15R and 15P, a write sensor 13, a carrying belt 18, a fuser 28, an ejection sensor 21, and ejection rollers 22 and 23, along a medium carrying path S that starts from a sheet supply cassette 24 and ends at an ejection tray 31.

Then, in the upper face part of the carrying belt 18 an image forming unit 2K that develops the developer image of black (K), an image forming unit 2Y that develops the developer image of yellow (Y), an image forming unit 2M that develops the developer image of magenta (M), and an image forming unit 2C that develops the developer image of cyan (C) are installed in a manner freely detachable from the printer 100 main body, in the order from the upstream side of the medium carrying path S. Also, directly above photosensitive drums 4K, 4Y, 4M, and 4C as image carriers that the respective image forming units 2K, 2Y, 2M, and 2C include therein, light emitting diode (LED) heads 3K, 3Y, 3M, and 3C which emit light based on input image information onto the surfaces of the photosensitive drums to form latent images thereon are respectively attached. Also, at the positions opposing the photosensitive drums 4K, 4Y, 4M, and 4C across the upper surface part of the carrying belt 18, transfer rollers 10K, 10Y, 10M, and 10C that transfer developer images developed on the surfaces of the respective photosensitive drums 4K, 4Y, 4M, and 4C onto the sheet P are arranged.

The sheet supply cassette 24 stores the sheets P stacked inside and is attached to the lower part of the printer 100 in a freely-detachable manner. The sheet supply cassette 24 feeds the stored sheets P from its uppermost part one by one into the medium carrying path by having a sheet supply roller 11 rotate by a driving force transmitted from a sheet supply motor 811 described later.

The first entrance sensor 120 and the second entrance sensor 12U are members that outputs information as to whether or not the sheet P has passed over each sensor to an image formation controller 700 described later, and in this case sensors which can detect a medium by mechanical motions, optical sensors which utilize reflection or transmission of light, and the like can be used.

The first carrying rollers 14R and 14P and the second carrying rollers 15R and 15P are installed in a state where the rollers of each pair are pressure-contacting with each other, rotate in a specified direction by a driving force transmitted from a carrying motor 812 described later, and carry the sheet P fed by the sheet supply roller 11 to the image forming units 2K, 2Y, 2M, and 2C while correcting the skew of the sheet P.

The write sensor 13 is a member which outputs information as to whether or not the sheet P has passed over the sensor to the image formation controller 700. The image formation controller 700 initiates image forming operations based on the information outputted from the write sensor 13. As the write sensor 13, sensors which can detect a medium by mechanical motions, optical sensors which utilize reflection or transmission of light, and the like can be used.

The carrying belt 18 is an endless belt member that carries the sheet P by electrostatic suction and is stretched by a belt driving roller 17 which rotates by a driving force transmitted from a carrying belt motor 801 described later and a belt driven roller 16 which is placed paired with said belt driving roller 17 and is supported by a spring to retain the tension of the carrying belt 18.

The fuser 28 is placed in the downstream side of the image forming units 2K, 2Y, 2M, and 2C on the medium carrying path S and is equipped with a fusion roller 19, fusion backup roller 20, a thermistor 792, and the like. The fusion roller 19 is formed by coating a core bar of hollow cylindrical shape made of aluminum, for example, with a heat-resistant elastic layer made of silicone rubber and coating a tetrafluoroethylene-perfluoroalkylvinylether copolymer (PFA) tube thereon. Then, a heater such as a halogen lamp is installed inside the core bar for example. The fusion backup roller 20 has a construction wherein a core bar made of aluminum for example is coated with a heat-resistant elastic layer made of silicone rubber and coated with PFA over it, and is arranged so that a nip part is formed between it an the fusion roller 19 by positive pressure given by the spring. The thermistor 792 is a device that the surface temperature of the fusion roller 19 and is installed near the fusion roller 19 in a non-contact manner. By controlling said heater based on the result of detecting the surface temperature of the fusion roller 19 by the thermistor 792, the surface temperature of the fusion roller 19 is maintained at a specified temperature. As the sheet P on which developer images developed in the image forming units 2K, 2Y, 2M, and 2C are transferred passes the nip part formed by the fusion roller 19 maintained at specified temperature and the fusion backup roller 20, heat and pressure are given to the developer on the sheet P, said developer is melted, and the developer image is fixed.

The ejection sensor 21 is a member which outputs information whether the sheet P has passed over the sensor to the image formation controller 700 described later. The image formation controller 700 initiates ejection operation of the sheet P on which the developer image has been fixed, based on the information outputted from the ejection sensor 21. As the ejection sensor 21, sensors which can detect a medium by mechanical motions, optical sensors which utilize reflection or transmission of light, and the like can be used.

The ejection rollers 22 and 23 sandwich and carries the sheet P which passed the fuser 28 and eject the sheet P onto the ejection tray 31 formed by utilizing the outer housing of the printer 100.

The image forming units 2K, 2Y, 2M, and 2C develop developer images corresponding to developer colors of black (K), yellow (Y), magenta (M), and cyan (C), respectively. The image forming units 2K, 2Y, 2M, and 2C having such a function includes development units 40K, 40Y, 40M, and 40C equipped with photosensitive drums 4K, 4Y, 4M, and 4C, charging rollers 5K, 5Y, 5M, and 5C, development rollers 6K, 6Y, 6M, and 6C, development blades 8K, 8Y, 8M, and 8C, toner supplying sponge rollers 9K, 9Y, 9M, and 9C, and cleaning blades 25K, 25Y, 25M, and 25C, respectively, and toner tanks 7K, 7Y, 7M, and 7C configured freely-detachable from the development units 40K, 40Y, 40M, and 40C, respectively.

The photosensitive drums 4K, 4Y, 4M, and 4C are each configured by a conductive support body and a photoconductive layers and are organic photosensitive bodies wherein a charge generation layer and a charge transport layer as the photoconductive layers are sequentially accumulated on a metal shaft made of aluminum for example as the conductive support body. Then, while rotating, the photosensitive drums 4K, 4Y, 4M, and 4C form latent images based on light irradiated from the LED heads 3K, 3Y, 3M, and 3C, respectively.

The charging rollers 5K, 5Y, 5M, and 5C are each configured by a metal shaft made of stainless steel and semiconductive epichlorohydrin rubber, for example. The charging rollers 5K, 5Y, 5M, and 5C are in contact with the photosensitive drums 4K, 4Y, 4M, and 4C with specified pressure and uniformly charge the surfaces of the photosensitive drums 4K, 4Y, 4M, and 4C, respectively, based on voltage charged by an high-voltage power supply (not shown).

The development rollers 6K, 6Y, 6M, and 6C each have urethane rubber with carbon black dispersed installed on the periphery of a metal shaft made of stainless steel for example, and its surface is isocyanate-treated. Then, the development rollers 6K, 6Y, 6M, and 6C are installed pressure-contacting with the respective surfaces of photosensitive drums 4K, 4Y, 4M, 4C, supply developers to the latent images formed on the photosensitive drums 4K, 4Y, 4M, and 4C while rotating, and develop the developer images.

The toner tanks 7K, 7Y, 7M, and 7C have spaces to store toners as developers corresponding to respective colors of black (K), yellow (Y), magenta (M), and cyan (C) and supply the developers to the toner supplying sponge rollers 9K, 9Y, 9M, and 9C, respectively.

The development blades 8K, 8Y, 8M, and 8C are formed into SUS of about 0.1 mm in thickness having springiness for example, and the tip of one end is bend in an L shape. Then, it is arranged so that their said tips contact with the development rollers 6K, 6Y, 6M, and 6C, respectively, with specified pressure-contacting force.

The toner supplying sponge rollers 9K, 9Y, 9M, and 9C each have a semiconductive silicone foam sponge layer installed on the periphery of a metal shaft made of stainless steel for example. The toner supplying sponge rollers 9K, 9Y, 9M, and 9C are in contact with the development rollers 6K, 6Y, 6M, and 6C with specified pressure and rotate and carry the developers supplied from the toner tanks 7K, 7Y, 7M, and 7C to the development rollers 6K, 6Y, 6M, and 6C, respectively.

The cleaning blades 25K, 25Y, 25M, and 25C are rubber members made of urethane for example, and their one ends are installed at positions in contact with specified positions on the surfaces of photosensitive drums 4K, 4Y, 4M, and 4C, respectively. The cleaning blades 25K, 25Y, 25M, and 25C clean the surfaces of photosensitive drums 4K, 4Y, 4M, and 4C by scratching out developers remaining on the surfaces of the photosensitive drums 4K, 4Y, 4M, and 4C.

More detailed constructions of the development parts 40K, 40Y, 40M, and 40C in the image forming units 2K, 2Y, 2M, and 2C of this embodiment will be explained later.

The LED heads 3K, 3Y, 3M, and 3C each have an LED element and a lens array and are installed in such positions that irradiation light beams emitted from the LED elements based on the control by the head controller 750 described later form images on the surfaces of the respective photosensitive drums 4K, 4Y, 4M, and 4C.

The transfer rollers 10K, 10Y, 10M, and 10C are arranged in respective positions opposing the photosensitive drums 4K, 4Y, 4M, and 4C across the upper face part of the transfer belt 18 and have developer images developed on the surfaces of the photosensitive drums 4K, 4Y, 4M, and 4C based on a specified voltage applied from the high voltage power supply (not shown) transferred onto the sheet P.

Although not shown in FIG. 1, the printer 100 is also equipped with a roller on the medium carrying path S installed at a distance less than the minimum inter-medium distance, a solenoid for switching the path of the medium carrying path S, and the like. Then, the printer 100 is equipped with a sheet supply motor 812 which gives a rotational driving force mainly to the sheet supply roller 11, a carrying motor 812 which gives rotational driving forces to the first carrying rollers 14R and 14P and the second carrying rollers 15R and 15P, a carrying belt motor 801 which gives a rotational driving force to the belt driving roller 17, a fixing motor 793 which gives rotational driving forces to the fusion roller 19, the fusion backup roller 20, and the ejection rollers 22 and 23, and mutually-independent K motor 781, Y motor 782, M motor 783, and C motor 784 which give rotational driving forces to the rollers of the image forming units 2K, 2Y, 2M, and 2C, respectively.

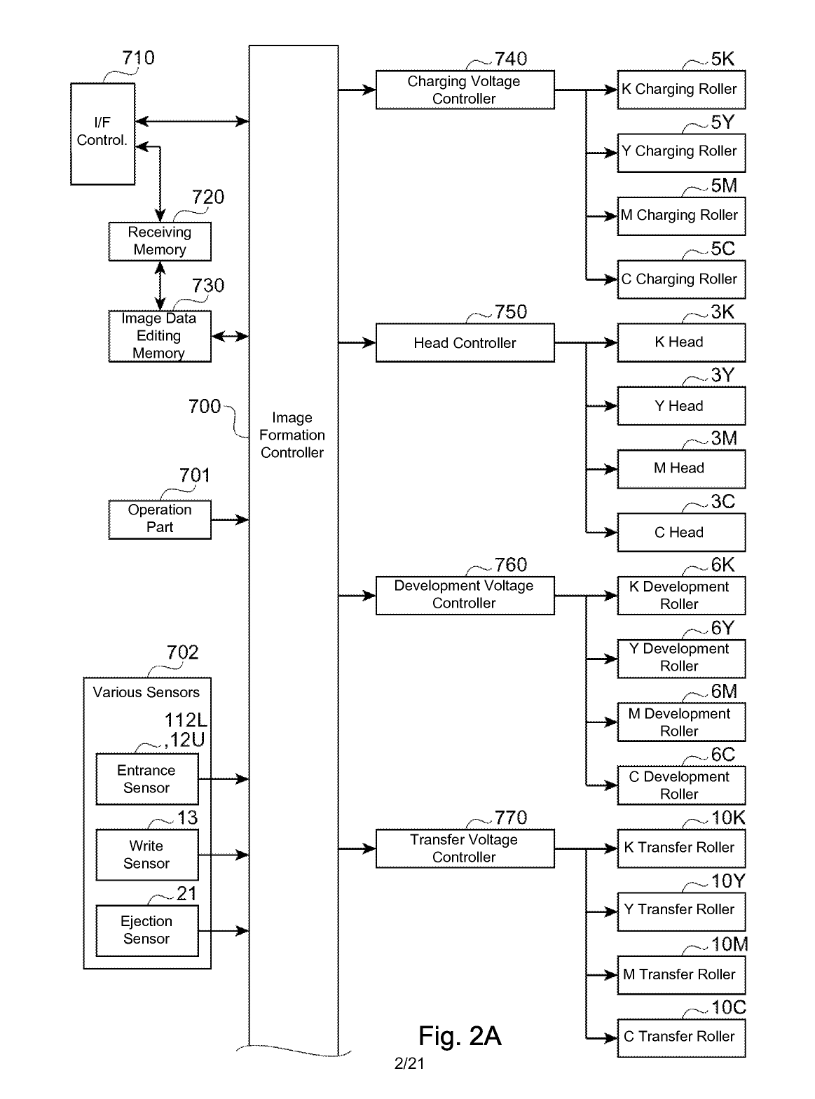

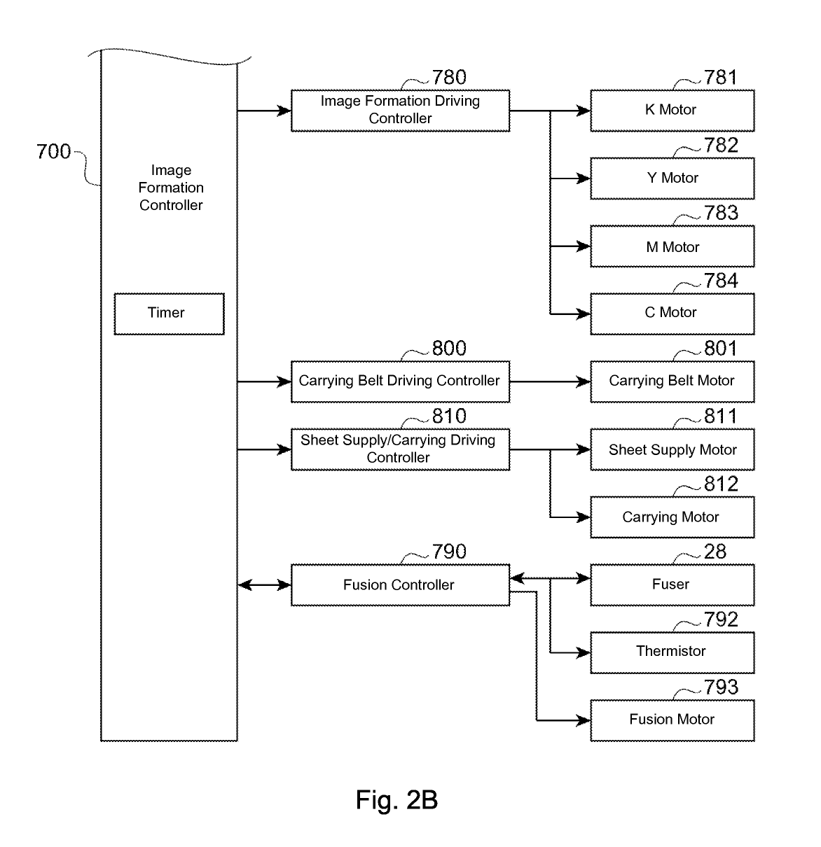

Next, the control mechanism of this embodiment is explained referring to a functional block diagram in FIG. 2.

The image formation controller 700 is equipped with a microprocessor, a read only memory (ROM), a random access memory (RAM), an input/output port, a timer, and the like, and controls the entire printer 100 by receiving image information and control commands from a host device.

The operation part 701 is equipped with a display such as a liquid crystal display (LCD) for displaying the status of the printer 100 and an input device such as a touch panel for receiving the input of user's instructions.

Various sensors 702 includes multiple sensors (a first entrance sensor 12L, a second entrance sensor 12U, a write sensor 13, and an ejection sensor 21) for detecting the carrying position of the sheet P, and information from those sensors are outputted to the image formation controller 700.

An I/F controller 710 sends printer information to its upper device, analyzes control commands received from the host device, and processes the received image information and the like.

A receiving memory 720 temporarily stores, by individual developer colors, the image information received from the host device based on the control by the I/F controller 710.

An image data editing memory 730 is a memory for editing the image information received from the host device via the I/F controller 710 as image data. The image data editing memory 730 receives the image information of individual colors which is temporarily stored in the receiving memory 720 and performs an editing process for outputting the received image information to the head controller 750.

A charging controller 740 controls the voltage applied to the charging rollers 5K, 5Y 5M, and 5C based on the instruction of the image formation controller 700.

The head controller 750 controls the LED heads 3K, 3Y, 3M, and 3C to irradiate the surfaces of the respective photosensitive drums 4K, 4Y, 4M, and 4C with irradiation light corresponding to image data outputted from the image data editing memory 730 based on the instruction of the image formation controller 700.

A development voltage controller 760 controls the voltage applied to the development rollers 6K, 6Y, 6M, and 6C to have developers attached to latent images on the surfaces of the photosensitive drums 4K, 4Y, 4M, and 4C formed by irradiation light emitted from the LED heads 3K, 3Y, 3M, and 3C based on the instruction of the image formation controller 700.

A transfer voltage controller 770 controls the voltage applied to the transfer rollers 10K, 10Y, 10M, and 10C to have developer images developed on the surfaces of the photosensitive drums 4K, 4Y, 4M, and 4C onto the sheet P based on the instruction of the image formation controller 700.

An image formation driving controller 780 controls the rotations of each of the photosensitive drums, the charging rollers, the development rollers, and the like by controlling the K motor 781, the Y motor 782, the M motor 783, and the C motor 784 based on the instruction of the image formation controller 700.

A fusion controller 790 controls the fuser 28 which fixes the developer images transferred onto the sheet P based on the instruction of the image formation controller 700. To be specific, the fusion controller 790 controls the voltage applied to the heater built in the fusion roller 19. Also, the fixing controller 790 maintains the surface temperature of the fusion roller 19 at a predetermined temperature by controlling the switching of on/off of the heater based on the detected temperature outputted from the thermistor 792. Furthermore, when the surface of the fusion roller 19 has reached a predetermined temperature, the fixing controller 790 rotates the fusion roller 19 by controlling the driving of the fusion motor 793.

A carrying belt controller 800 drives the carrying belt 18 by causing the belt driving roller 17 to be rotated by controlling the driving of the carrying belt motor 811 based on the instruction of the image formation controller 700.

A sheet supply/carrying driving controller 810 feeds/carries the sheet P to the position of the carrying belt 18 by causing the sheet supply roller 11, the first carrying rollers 14R and 14P, the second carrying rollers 15R and 15P, and the like to be rotated rotate by controlling the driving of the sheet supply motor 811 and the carrying motor 812 based on the instruction of the image formation controller 700.

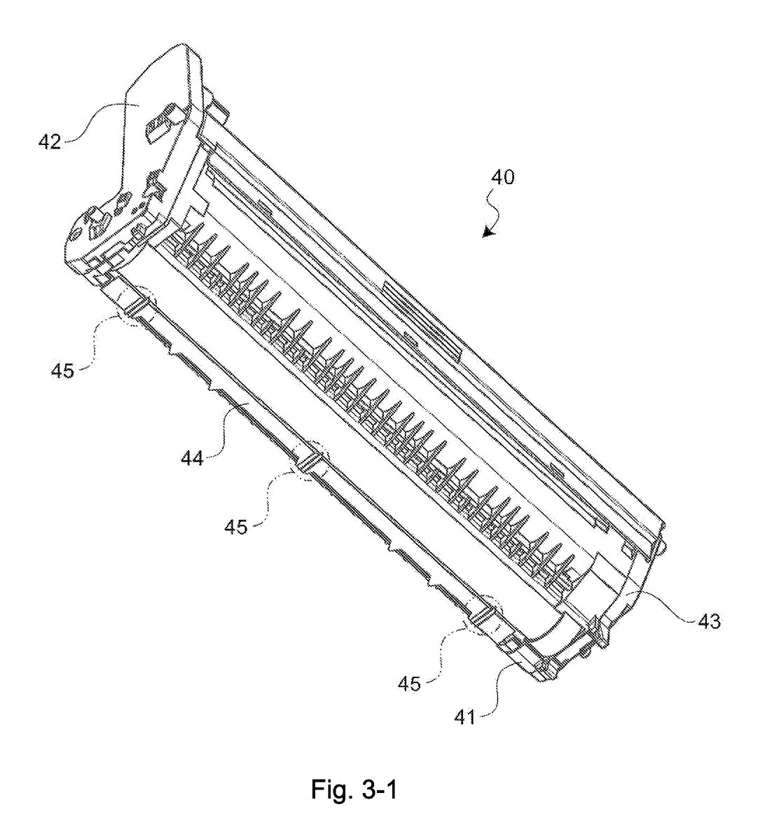

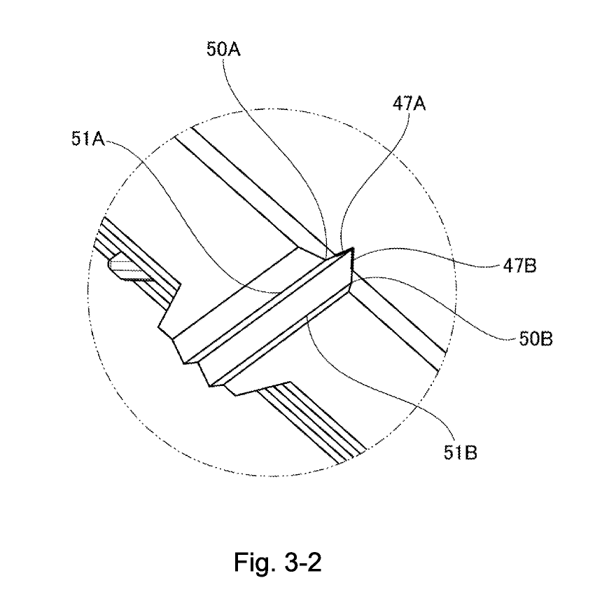

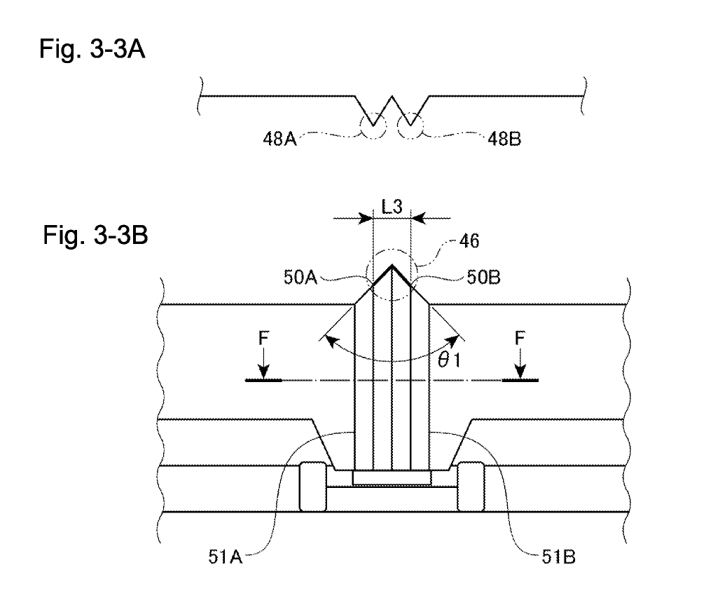

Next, the configurations of the development parts 40K, 40Y, 40M, and 40C of the image forming units 2K, 2Y, 2M, and 2C of this embodiment are explained in more detail referring to FIGS. 3-1, 3-2, 3-3A and 3-3B. FIG. 3-1 is a bottom perspective view of the development parts 40K, 40Y, 40M, and 40C of the present embodiment. FIG. 3-2 is a perspective view of the contact part of this embodiment. FIGS. 3-3A and 3-3B are a bottom view and an F-F cross-sectional view of the contact part of the present embodiment. Here, the configurations of the development parts 40K, 40Y, 40M, and 40C are all identical. Therefore, the symbols K, Y, M, and C will be omitted, and only numbers will be used in the following explanation.

The development part 40 includes the photosensitive drum 4, the charging roller 5, the development roller 6, the development blade 8, the toner supplying sponge roller 9, and the cleaning blade 26. Shafts (not shown) of these members are fixed by a frame base 41, a frame side 42, and a frame side 43.

Then, a separation member 44 for separating the front end of the sheet P from the surface of the photosensitive drum 4 is affixed to the frame base 41 with an adhesive or the like.

The separation member 44 is made of flexible material such as PET film of about 0.2 mm in thickness and has a plurality of contact parts 45 in contact with the surface of the photosensitive drum 4. The contact parts 45 are formed by bending the separation member 44, and the angle θ1 of the tip part 46 is formed in a range 45°≦θ1≦135° (preferably 45°≦θ1≦90°).

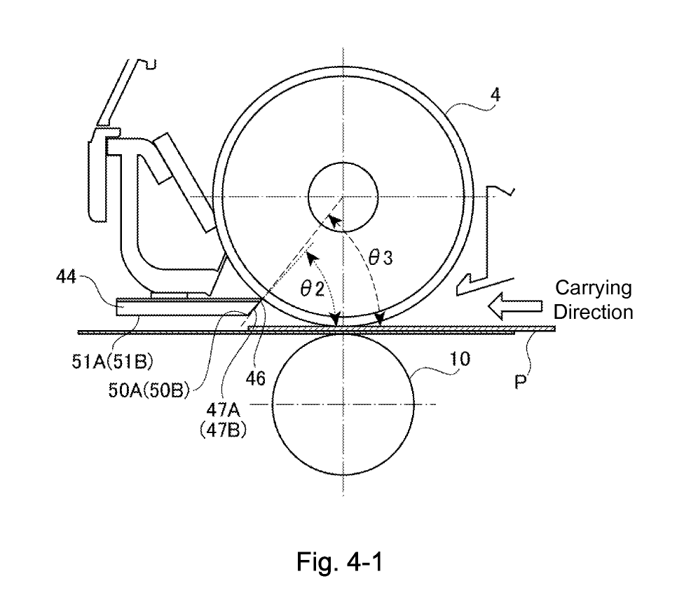

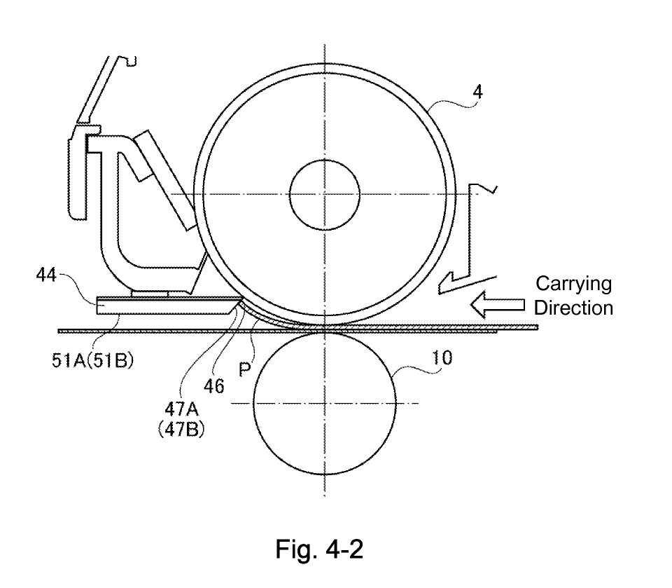

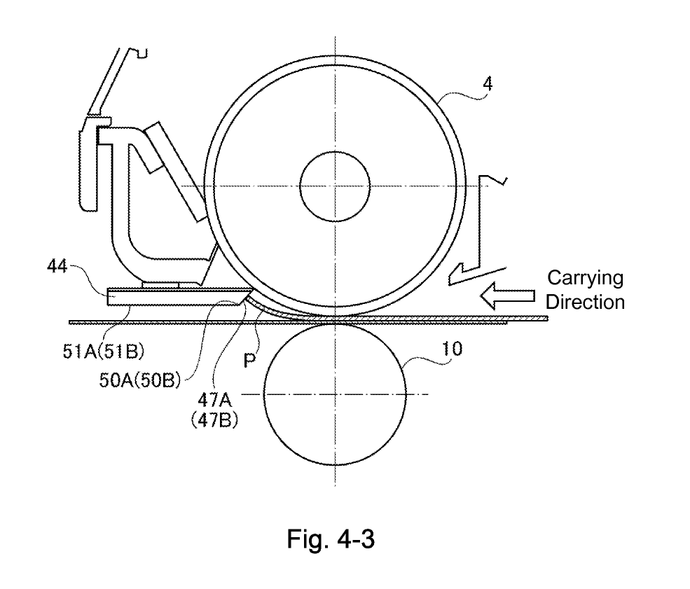

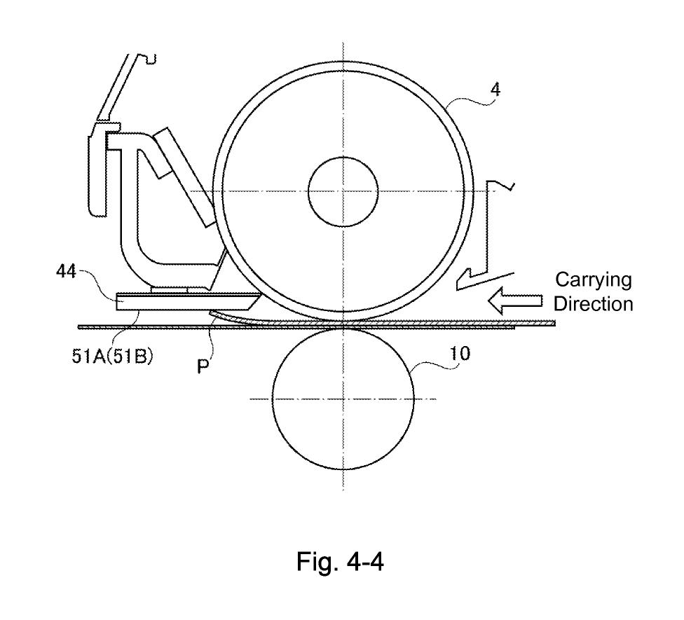

Then, on each contact part 45, ridge parts 47A and 47B are formed in the same shape and face the transfer roller 10 side, from the tip part 46, toward the downstream side of medium carrying direction and to two bending positions 48A and 48B. Also, as shown in FIG. 4-1, an angle θ2 formed by the ridge parts 47A and 47B and the medium carrying direction is formed with a specified angle in the direction away from the photosensitive drum 4. To be specific, the angle θ2 can be formed so as to be 10°≦θ2≦70°, and if the angle formed by an auxiliary line connecting the central axis of the photosensitive drum 4 and the tip part 46 and the medium carrying direction is denoted as θ3, they are formed so that the relationship between θ2 and θ3 becomes θ2<θ3. Furthermore, each contact part 45 includes ridge parts 51A and 51B formed approximately parallel toward the downstream side in the medium carrying direction from the ridge positions 50A and 50B of the bending positions 48A and 48B in the ridge parts 47A and 47B.

Next, the image formation process of the printer 100 having said construction is explained.

The image formation controller 700 receives control commands and image information sent from the host device via the I/F controller 710. Then, when a print instruction is received from the host device, the image formation controller 700 instructs the sheet supply/carrying driving controller 810 on a specified medium carrying speed to cause the sheet supply roller 11 to be rotated to feed a sheet P from the sheet supply cassette 24.

The first entrance sensor 12L installed in the middle of the medium carrying path S detects the carrying position of the sheet P and outputs the detection result to the image formation controller 700. Here, the first entrance sensor 12L is installed for the purposes of repeating the paper supply action if the supply of the sheet P is not performed normally and correcting the skew motion of the sheet P by the image formation controller 700 abutting the front end of the sheet P against the first carrying rollers 14R and 14P by controlling the drive timing of the first carrying rollers 14R and 14P.

The sheet P carried to the first carrying rollers 14R and 14P is carried to the image forming unit 2K by the second carrying rollers 15R and 15P.

Each of the rollers provided in the image forming units 2K, 2Y, 2M, and 2C start rotating at about the same time as the supply of the sheet P starts under the control of the image formation driving controller 780. At this time, negative voltage (about −1000 V) is applied to the charging rollers 5K, 5Y, 5M, and 5C by the control of the charging voltage controller 740 based on the instruction by the image formation controller 700 to uniformly charge the surfaces of the photosensitive drums 4K, 4Y, 4M, and 4C.

Then, the respective developers used for printing are supplied from the toner tanks 7K, 7Y, 7M, and 7C via the toner supplying sponge rollers 9K, 9Y, 9M, and 9C to the development rollers 6K, 6Y, 6M, and 6C. The developers supplied to the development rollers 6K, 6Y, 6M, and 6C are friction-charged by the development blades 8K, 8Y, 8M, and 8C.

At this time, along with the start of the rotations of the photosensitive drums 4K, 4Y, 4M, and 4C, the carrying belt 18 also starts being driven at the same speed as the rotation speed of the photosensitive drums 4K, 4Y, 4M, and 4C by the rotation of the belt driving roller 17.

The sheet P is carried further by the second carrying rollers 15R and 15P and turns on the write sensor 13. When specific time has passed after the front end of the sheet P is detected by the write sensor 13, the image formation controller 700 instructs the head controller 750 to start light exposure by controlling the LED head 3K to form a latent image on the surface of the photosensitive drum 4K.

A developer is provided from the development roller 6K to the latent image formed on the surface of the photosensitive drum 4K, and thereby a developer image is developed. Then, the image formation controller 700 instructs the transfer voltage controller 770 to apply positive voltage (about +3000 V) to the transfer roller 10K at the timing when the sheet P has reached the nip part formed between the photosensitive drum 4K and the transfer roller 10K.

The transfer voltage controller 770 which has received the instruction controls a high-voltage power supply (not shown) to apply the voltage to the transfer roller 10K to attract the developer image on the photosensitive drum 4K toward the sheet P side and transfer the developer image onto the sheet P. These image formation processes are also sequentially performed in other image forming units 2Y, 2M, and 2C along the carrying of the sheet P.

When all the developer images developed by the image forming units 2K, 2Y, 2M, and 2C have been transferred onto the sheet P, heat and pressure are provided to the sheet P in the fuser 28 so that the developer image fixed onto the sheet P. After the fusion of the developer image is finished, the sheet P turns on the ejection sensor 21 for jam monitoring and the medium length detection after the fusion and is ejected onto the ejection tray 31 by the ejection rollers 22 and 23.

Next, actions of the development part 40 while carrying a medium are explained referring to FIGS. 4-1, 4-2, 4-3, and 4-4.

First, the normal case where the front end of the sheet P does not curl is explained by referring to FIG. 4-1. When the sheet P is carried to the position of the nip part between the photosensitive drum 4 of the development part 40 and the transfer roller 10, the front end of the sheet P is carried in an approximately perpendicular direction to the nip part direction between the photosensitive drum 4 and the transfer roller 10. Then, if the sheet P is further carried by the photosensitive drum 4 and the transfer roller 10, the front end of the sheet P does not touch the contact part 45 (the tip part 46 or two ridge parts 47A and 47B, and 51A and 51B) of the separation member 44 contacting with the surface of the photosensitive drum. Therefore, even if the sheet P is carried by the photosensitive drum 4 and the transfer roller 10, a transferred image formed on the surface of the sheet P is not smeared, and the sheet P is carried to the next development part in the downstream side of the medium carrying direction and the fuser 28.

Next, the case where the front end of the sheet P curls toward the surface side of the photosensitive drum is explained by referring to FIGS. 4-2, 4-3, and 4-4. When the sheet P is carried to the nip part position between the photosensitive drum 4 of the development part 40 and the transfer roller 10, the sheet P with its front end curling toward the photosensitive drum side is carried along the surface of the photosensitive drum.

Then, if the sheet P is further carried by the photosensitive drum 4 and the transfer roller 10, as shown in FIG. 4-2, the front end of the sheet P touches the contact part 45 of the separation member 44 contacting with the surface of the photosensitive drum 4. Here, because the contact part 45 is in contact with the surface of the photosensitive drum 4, the front end of the curled sheet P I separated from the surface of the photosensitive drum 4 by the tip part 46 of the contact part 45. Because the separation member 44 is formed of a flexible material such as PET film of about 0.2 mm in thickness, the front end of the sheet P does not become bent or hooked.

Afterwards, if the sheet P is further carried by the photosensitive drum 4 and the transfer roller 10, as shown in FIG. 4-3, the front end of the sheet P is carried along the ridge parts 47A and 47B formed by the bent shape of the separation member 44. Here, because the front end of the sheet P curls toward the surface side of the photosensitive drum, the place where the sheet P contacts with the ridge parts 47A and 47B of the separation member 44 is only the edge part of the front end of the sheet P. Moreover, the two ridge parts 47A and 47B of the separation member 44 are formed at an angle of θ1 relative to the medium carrying direction up to the bending positions 48A and 48B, as shown in FIG. 3-3B, the range of contact between the edge part of the front end of the sheet P and the ridge parts 47A and 47B becomes L3 in distance (here, preferably L3<5 mm).

When the sheet P is even further carried, as shown in FIG. 4-4, because the front end of the sheet P is carried with only its edge part in point-contact with the ridge parts 51A and 51B of the separation member 44, the contact width in the edge part of the front end of the sheet P becomes only L3, and the sheet P is carried to the next development part in the downstream side of the medium carrying direction and the fuser 28 without smearing a transferred image formed on the surface of the sheet P.

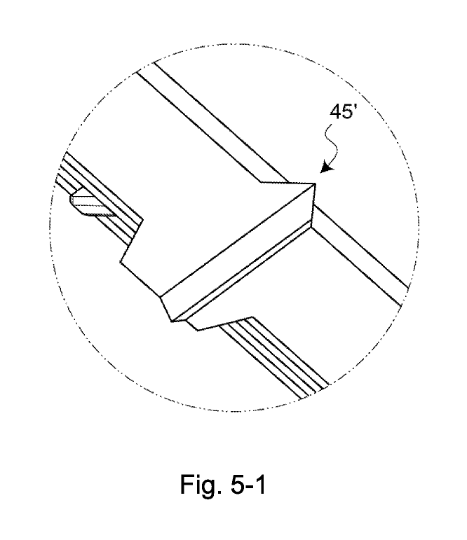

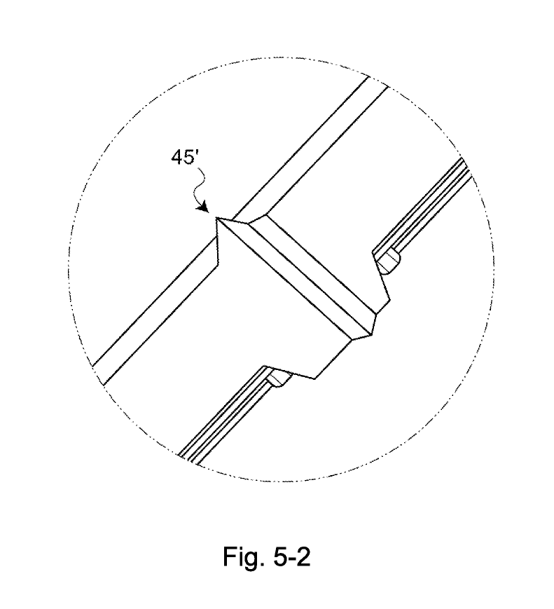

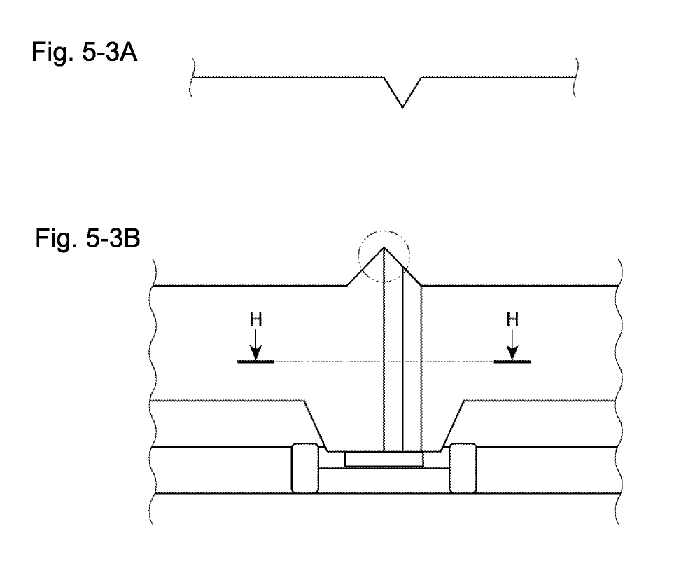

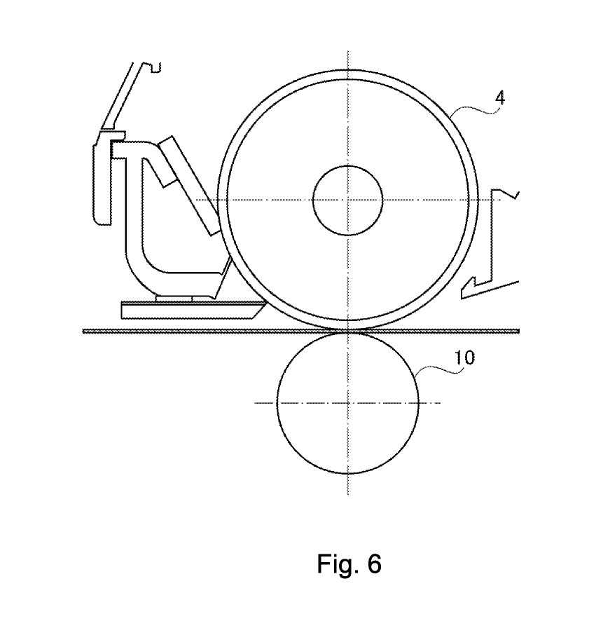

Although the contact part 45 explained in the first embodiment is formed with a five-time bent shape of the separation member 44, the present invention is not limited to this. In other words, as a modification example, the contact part 45′ shown in FIGS. 5-1, 5-2, 5-3A, 5-3B and 6 is formed with a three-time bent shape of the separation member 44, and a similar effect to that of the first embodiment is obtained by the separation member 44 having the contact part 45′ shown in the modification example. In this case, unlike in the first embodiment, the sheet P is carried with the edge part of the front end in point-contact with one of the ridge parts of the contact part 45′.

As stated above, according to the first embodiment, when carrying a normal sheet with its front end not curling, because the surface of the sheet does not touch the separation member, a transferred image formed on the sheet P is not smeared, and even when carrying a sheet with its front end curling, because the sheet P is carried only with the edge part of the front end of the sheet contacting the two ridge parts of the separation member, a transferred image formed on the sheet P is not smeared. Therefore, good carrying can be performed.

### Second Embodiment

The configurations of the printer and the development part of a second embodiment are approximately the same as those explained in the first embodiment. In the second embodiment, explanations on the same parts as those in the first embodiment are omitted, and different parts are explained.

A separation member 60 in the second embodiment has a configuration which has no bent shape unlike the separation member 44 in the first embodiment and has no ridge parts 47A and 47B or ridge parts 51A and 51B provided by the contact part 45.

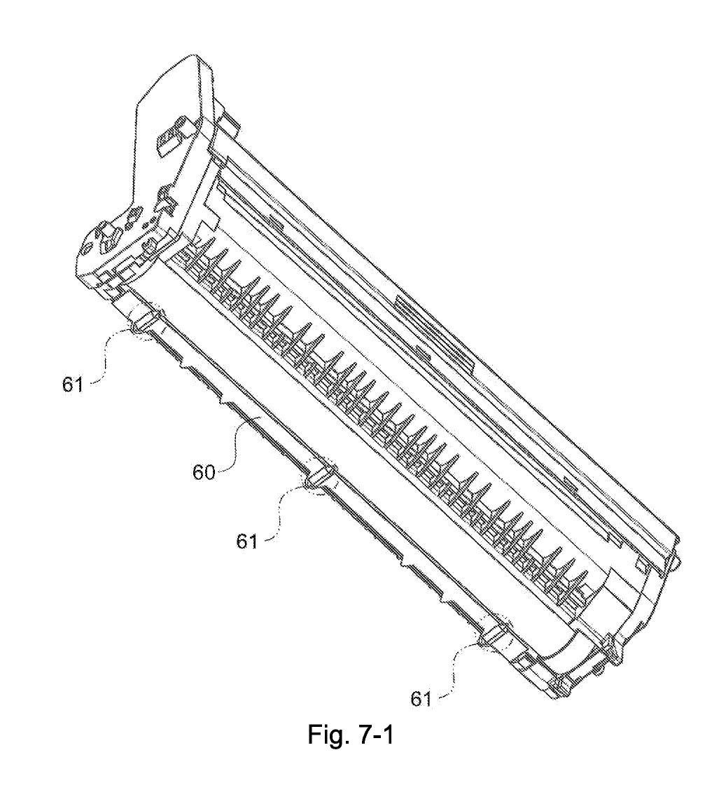

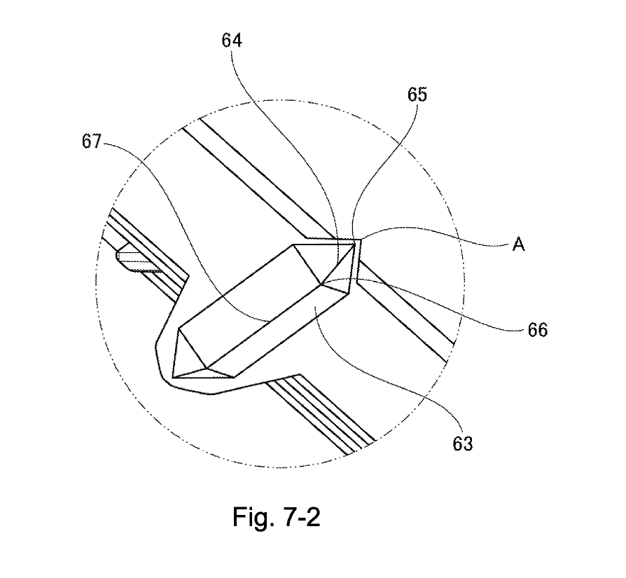

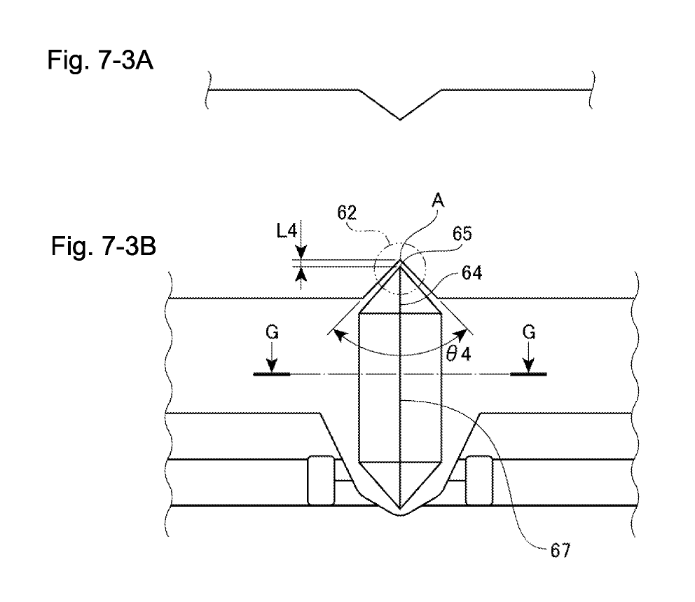

FIGS. 7-1, 7-2, 7-3A and 7-3B are drawings for explaining the configuration of the development part of the second embodiment. FIG. 7-1 is a bottom perspective view of the development part of the present embodiment. FIG. 7-2 is a perspective view of the contact part of the present embodiment. FIGS. 7-3A and 7-3B are a bottom view and a G-G cross-sectional view of the contact part of the present embodiment.

The separation member 60 is made of a flexible material such as PET film of about 0.2 mm in thickness includes has multiple contact parts 61 in contact with the surface of the photosensitive drum 4. An angle θ4 of the tip part 62 of the contact parts 61 is formed in a range 45°≦θ4≦135° (preferably 45°≦θ4≦90°.

The contact pat 61 is formed as an elongated triangular bipyramid convex part 63 with a triangular pyramid placed on each end of a triangular prism, from the tip part 62 toward the transfer roller 10 side in the downstream side of the medium carrying direction. On the convex part 63, a ridge part 64 is formed, as the first ridge part utilizing one edge of the triangular pyramid part, from the vicinity of the tip part 62. An angle θ5 formed by the ridge part 64 and the medium carrying direction is formed as a specified angle in the direction away from the photosensitive drum 4. To be specific, the angle θ5 can be formed in a range 10°≦θ5≦70°, and if an angle formed by an auxiliary line connecting the central axis of the photosensitive drum 4 and the tip part 62, and the medium carrying direction is denoted as θ6, they are formed so that the relationship between θ5 and θ6 becomes θ5<θ6. Here, the vicinity of the tip part 62 is the position where the distance L4 from point A of the tip part 62 to the starting point 65 of the ridge part 64 should satisfy L4<1 mm, and preferably L4=0. Furthermore, on the convex 63, a ridge part 67 is formed as the second ridge part utilizing a linear part of one edge of the triangular prism part, parallel with the medium carrying direction toward the downstream side in the medium carrying direction from the ridge position 66 which is the end of the ridge part 64.

Here, the convex part 63 may also be integrally molded with a flexible material (PET file material) configuring the separation member 60 or molded as a shape with a ridge part installed on a part of the flexible material. Also, the convex part 63 may be molded by extruding a flexible material or extruding ridges on a flexible material. Furthermore, these ridges (ridge parts) may be formed in the vicinity of the contact position with the photosensitive drum. Here, although explanations are given on a shape having a triangular pyramid placed on each of both end bottom parts of the triangular prism as a form of the convex part 63, the form of the convex part 63 is not limited to this. The convex part 63 may be in a shape with a triangular pyramid placed only on the base of the triangular prism on the tip part 62 side. Moreover, the shape of the triangular pyramid may be slightly rounded, for example. If the ridge part 64 as the first ridge part is formed to have the angle of θ5 (10°<θ5<70°) relative to the carrying direction of the sheet P, and if the ridge part 67 as the second ridge part is formed extending from the ridge position 66 of the ridge part 64 parallel with the carrying direction of the sheet P, there is no limitation on the shape of the convex part 63.

Next, actions of the development part 40 while carrying the medium is explained referring to FIGS. 8-1, 8-2, 8-3, and 8-4.

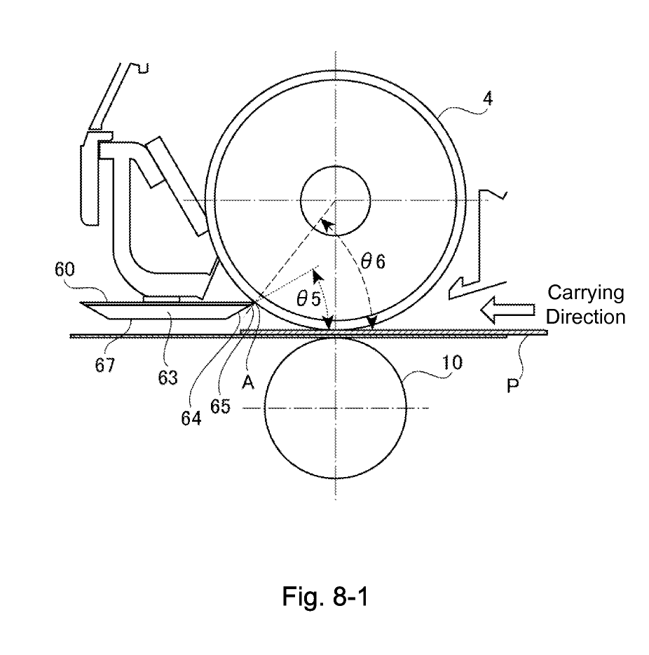

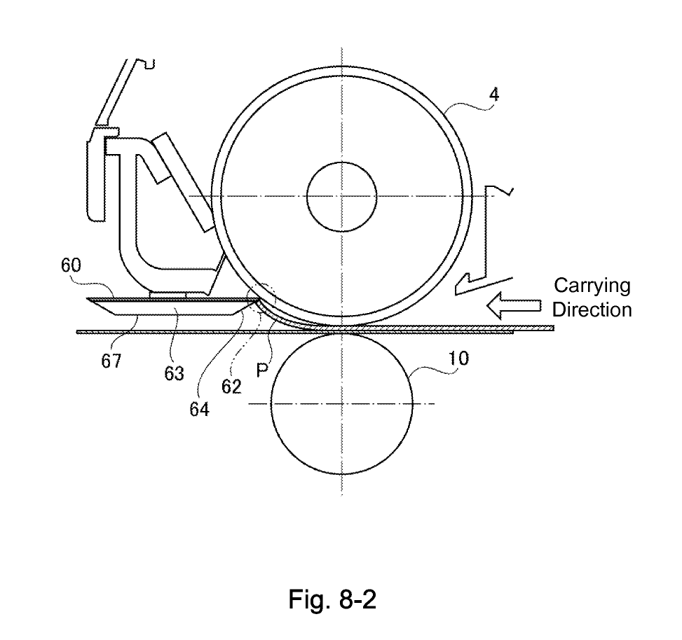

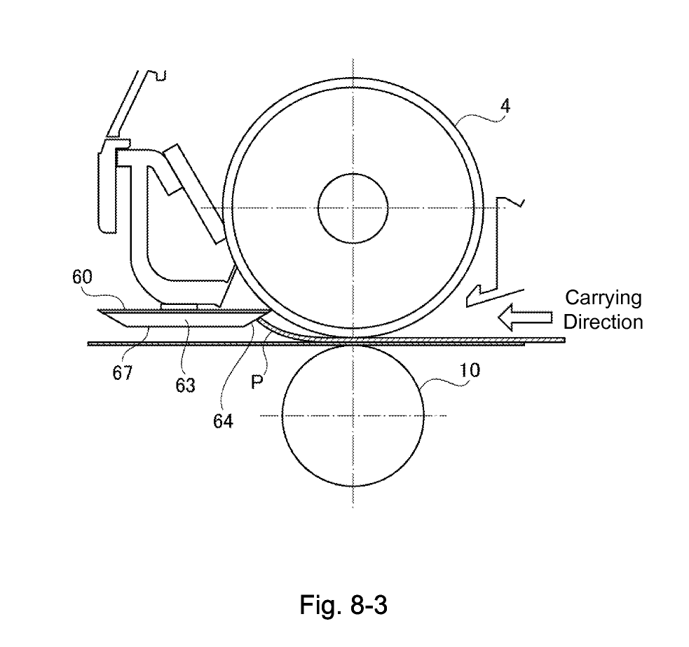

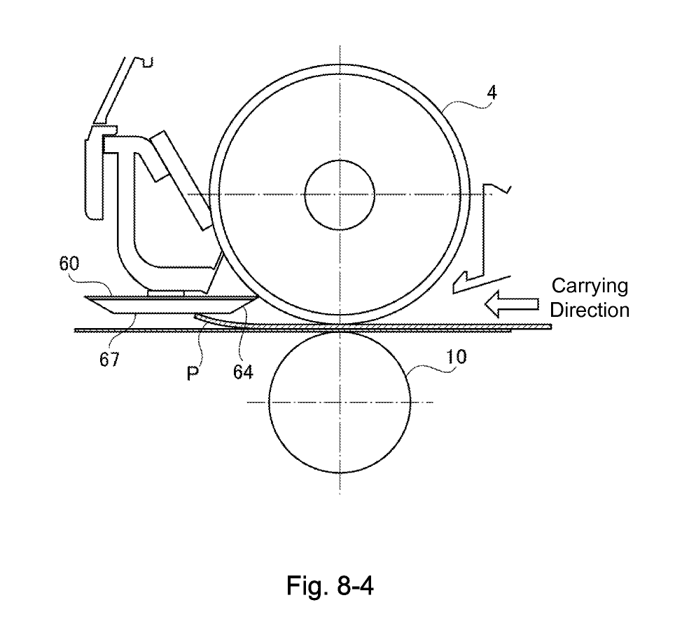

First of all, the standard case wherein the front end of the sheet P does not curl is explained referring to FIG. 8-1. When the sheet P is carried to the nip part position between the photosensitive drum 4 of the development part 40 and the transfer roller 10, the front end of the sheet P is carried in an approximately perpendicular direction to the nip part direction between the photosensitive drum 4 and the transfer roller 10. Then, when the sheet P is further carried by the photosensitive drum 4 and the transfer roller 10, the front end of the sheet P does not touch the contact part 61 (the tip part 62 and the convex part 63) of the separation member 60 contacting with the surface of the photosensitive drum. Therefore, even if the sheet P is carried by the photosensitive drum 4 and the transfer roller 10, a transferred image formed on the surface of the sheet P is not smeared, and the sheet P is carried to the next development part in the downstream side of the medium carrying direction and the fuser 28.

Next, the case where the front end of the sheet P curls toward the surface side of the photosensitive drum is explained referring to FIGS. 8-2, 8-3, and 8-4. When the sheet P is carried to the nip part position between the photosensitive drum 4 of the development part 40 and the transfer roller 10, the sheet P with its front end curling toward the photosensitive drum side is carried along the photosensitive drum surface.

Then, when the sheet P is further carried by the photosensitive drum 4 and the transfer roller 10, as shown in FIG. 8-2, the front end of the sheet P touches the contact part 61 of the separation member 60 contacting with the surface of the photosensitive drum 4. Here, the contact part 61 is separated from the surface of the photosensitive drum 4 by the tip part 62 of the contact part 61. Because the separation member 60 is formed of flexible material such as PET film of about 0.2 mm in thickness, the front end of the sheet P never becomes bent or hooked.

Afterwards, when the sheet P is further carried by the photosensitive drum 4 and the transfer roller 10, as shown in FIG. 8-3, the sheet P is carried along the ridge part 64 formed by the convex part 63 of the separation member 60. Here, because the front end of the sheet P curls toward the surface side of the photosensitive drum, the place where the sheet P touches the ridge part 64 of the separation member 60 is only the edge part of the front end of the sheet P. Then, because the ridge part 64 of the separation member 60 is formed parallel with the medium carrying direction, contact between the edge part of the front end of the sheet P and the ridge part 64 becomes only a point contact.

When the sheet P is further carried, as shown in FIG. 8-4, the front end of the sheet P has only the edge part in point-contact with the ridge part 67 of the separation member 60 during the carrying, and because the ridge part 64 and the ridge part 67 are formed on the same straight line which is approximately parallel to the medium carrying direction, the contact width in the edge part of the front end of the sheet P also becomes point-contact only, which allows the sheet P to be carried to the next development part in the downstream side of the medium carrying direction and the fuser 28 without contaminating a transferred image formed on the surface of the sheet P.

As stated above, according to the second embodiment, when a standard sheet with the front end not curling is carried, because the surface of the sheet does not touch the separation member, a transferred image formed on the sheet P is not smeared, and even when a sheet with the front end curling is carried, because it is carried only the edge part of the front end of the sheet point-contacting with the continuous ridge part of the separation member, the contact track on the edge part becomes only one point as opposed to the first embodiment, and a transferred image formed on the sheet P is not smeared. Therefore, good carrying can be performed.

In the explanation of the embodiments of the present invention, a form utilizing mutually independent K motor 781, Y motor 782, M motor 783, and C motor 784 for driving the image forming units 2K, 2Y, 2M, and 2C, respectively, was explained. However, the embodiments are not limited to this. A form driving all the image forming units with one motor may be adopted. Also, in the explanation of the embodiments of the present invention a printer equipped with our image forming units was explained. However, the present invention is also applicable to an image forming apparatus equipped with an image forming unit of a single color, such as black.

Furthermore, in the explanation of the embodiments of the present invention, the photosensitive drum as an image carrier is discussed using a rotation body as an object in which the separation member is included. However, the present invention is applicable to other rotation bodies, such as the fusion roller, on which the sheet is expected to attach.

Also, in the explanation of the embodiments of the present invention, a printer was explained as an example of the image forming apparatus. However, the present invention is applicable in any other image forming apparatus which prints by an electrographic method such as a multifunction printer, facsimile, copier and the like.

What is claimed is:

1. An image forming member, comprising:
a rotation body that is configured to rotate in contact with a medium and to form an image on the medium; and
a separation member that is positioned in contact with or in a vicinity of the surface of the rotation body and that separates the medium attached to the rotation body, wherein
the separation member includes a plurality of partial contact parts formed along a rotational axis direction of the rotation body, and a plurality of ridge parts respectively formed from the partial contact parts toward the downstream of a carrying direction of the medium.

2. The image forming member according to claim 1, wherein
the ridge parts are formed with a bent shape of the separation member.

3. The image forming member according to claim 1, wherein
one of the ridge parts includes a first ridge part formed with a specified angle in the direction away from the rotation body relative to the carrying direction of the medium, and a second ridge part formed extending from an end of the first ridge part and in parallel with the carrying direction of the medium.

4. The image forming member according to claim 1, wherein
each of the ridge parts includes a first ridge part formed with a specified angle in the direction away from the rotation body relative to the carrying direction of the medium, and a second ridge part formed extending from an end of the first ridge part and in parallel with the carrying direction of the medium.

5. The image forming member according to claim 3, wherein
the first ridge part and the second ridge part are formed with a convex shape of the separation member.

6. The image forming member according to claim 4, wherein
the first ridge part and the second ridge part are formed with a convex shape of the separation member.

7. The image forming member according to claim 1, wherein
the ridge parts are in a triangular pyramid shape.

8. The image forming member according to claim 1, wherein
the separation member is formed of a flexible material.

9. The image forming member according to claim 1, wherein
the partial contact parts and the ridge parts are formed by a five-time bent shape of the separation member.

10. The image forming member according to claim 1, wherein
the partial contact parts and the ridge parts are formed by a three-time bent shape of the separation member.

11. The image forming member according to claim 1, wherein
the rotation body is an image carrier.

12. The image forming member according to claim 1, wherein
the rotation body is a fusion roller.

13. An image forming apparatus, comprising:
the image forming member according to claim 1;
a transfer device that is configured to transfer a developer image carried on the rotation body onto the medium; and
a fusion device that is configured to fix the developer image transferred onto the medium, wherein
the rotation body is an image carrier.
